(19) United States
(12) Patent Application Publication
(10) Pub. No.: US 2009/0171979 A1
(43) Pub. Date: Jul. 2, 2009

(54) SYSTEM AND METHOD FOR A WEB-BASED ADDRESS BOOK

(75) Inventors: DAN LUBARSKI, WATERTOWN, MA (US); SERGEY PORFIRIEV, NEWTON, MA (US); SERGEY PRAZDNICHKOV, MOSCOW (RU)

Correspondence Address: AKC PATENTS, 215 GROVE ST., NEWTON, MA, 02466, US

(73) Assignee: HUMANBOOK, INC., WELLESLEY HILLS, MA (US)

(21) Appl. No.: 12/342,932

(22) Filed: Dec. 23, 2008

Related U.S. Application Data
(60) Provisional application No. 61/017,452, filed on Dec. 28, 2007.

(51) Int. Cl. G06F 17/30

(52) U.S. Cl. 707/10; 707/E17.001

(57) ABSTRACT

An online system and a method for a web-based address book that allows collaborative updating and synchronization of the listed persons' contact information. The method includes creating profile templates for each person within a group and storing these profile templates in a central database. Next, populating the profile templates with publicly available basic information and then publishing the public profile information in the web-based address book. Users login into the address book website, update their own profile information and upload their personal address book. The system then cross-correlates and matches contact information retrieved from users' personal address books to the contact information listed in other persons' profiles.

### CROSS REFERENCE TO RELATED CO-PENDING APPLICATIONS

This application claims the benefit of U.S. provisional application Ser. No. 61/017,452 filed on Dec. 28, 2007 and entitled SYSTEM AND METHOD FOR A WEB-BASED ADDRESS BOOK which is commonly assigned and the contents of which are expressly incorporated herein by reference.

This application is also related and claims the benefit of U.S. provisional application Ser. No. 61/017,408 filed on Dec. 28, 2007 and entitled SYSTEM AND METHOD FOR A WEB-BASED PEOPLE DIRECTORY which is commonly assigned and the contents of which are expressly incorporated herein by reference.

This application is also related to and claims the benefit of co-pending U.S. provisional application Ser. No. 61/017,465 filed on Dec. 28, 2007 and entitled SYSTEM AND METHOD FOR A WEB-BASED NETWORKING DATABASE which is commonly assigned and the contents of which are expressly incorporated herein by reference.

This application is also related to and claims the benefit of U.S. provisional application Ser. No. 61/022,633 filed on Jan. 22, 2008 and entitled SYSTEM AND METHOD FOR A WEB-BASED PEOPLE PICTURE DIRECTORY which is commonly assigned and the contents of which are expressly incorporated herein by reference.

### FIELD OF THE INVENTION

The present invention relates to a system and a method for a web-based address book, and in particular to a web-based address book that allows collaborative updating of the listed contact information.

### BACKGROUND OF THE INVENTION

A person uses address books for storing and maintaining contact information for people belonging to the person's social network. Address books include lists of names and addresses (home, business, school, seasonal, temporary), phone numbers, e-mail addresses, web-site information, instant messaging information, online identification and other vital information such as birthdays, hobbies, education, preferences, pictures and stories, associated with the listed names. Address books may have the form of a physical printed book or may be address book files stored in servers, personal digital assistants (PDA), phones, or other computing or communications devices, or may be online address books.

Online address books invite people to register in a website and then upload contact information for people belonging to their personal and business network. One such example is “The Internet Address Book” at www.internetaddressbook.com. This website also allows the users to search the web for the contact information of people belonging to a person's network, actively manage a person's contact information, i.e., edit, update, add or delete, and discover other people's social network. A name based search usually involves searching online social network groups for information pertaining to the name of the person being searched. Examples of social network groups include www.Facebook.com, www.MySpace.com, www.friendster.com, www.linkedIn.com, www.Zoominfo.com, www.Flickr.com, www.ICQ.com, www.Buzznet.com, www.Xanga.com and online alumni network of people who attended a specific college or university. These social network groups allow a user to create a personal profile, store it in the social network's database and publish it to the group. The published information is usually not verified by a third party and may be fictitious. A group member accesses his profile by logging into the group's website via a user identification and password and enters and/or modifies his profile information content. Access to the user's profile by other network members is controlled by the user. These prior art systems rely upon each group member actively managing and updating his online profile content and contact information. However, this usually does not happen. Therefore the retrieved contact information may be wrong, outdated and in general not reliable. Furthermore, there is no way for correcting the published contact information by anyone else but the member. Furthermore, the contact information is only available to the members of a specific group and is not publicly available.

Accordingly, there is a need for an online system and method for an address book that provides reliable and real-time updated contact information for all listed people and entities.

### SUMMARY OF THE INVENTION

In general, in one aspect, the invention features a computer implemented method for an online address book including the following. First, generating a profile template for each person within a group and storing them in a central database and then populating each person's profile template with publicly available information. Next, publishing each person's profile template through a web-based address book application executing on a first computing device. The web-based address book application is adapted to be accessed by a first person of the group through a browser executing on a second computing device. The second computing device is adapted to connect to the first computing device via a network connection. Next, providing a first webpage adapted to be viewed by the first person via the browser for the first person to login into the web-based address book application and to search the first person's own profile template in the central database. Next, retrieving the first person's own profile template and displaying it in a second webpage adapted to be viewed by the first person through the browser. Next, uploading the first person's personal address book and adding the uploaded personal address book to the first person's profile template. The personal address book comprises names and contact information of the first person's personal contacts. Next, cross-correlating the uploaded names and contact information of the first person's personal contacts with information in the personal contacts' profile templates stored in the central database and updating the personal contacts' profile templates.

Implementations of this aspect of the invention may include one or more of the following features. The profile template has one or more fields including last name, first name, address, age, date of birth, phone number, e-mail address, education background, work address, personal address book, personal contacts and pictures. The method further includes selecting one or more of the fields to be publicly displayed in the profile template. The method further includes updating the first person's profile information by the first person. The method further includes displaying the updated profile template and uploaded personal address book of the first person in the second webpage. The method further includes verifying and updating the first person's profile information by other persons of the group. The method further includes updating the contact information of the first person's personal contacts in the first person's personal address book based on information in the personal contact's profile templates. The method further includes inviting the first person's personal contacts to join the web-based address book application, verify information in their personal profile templates and then upload their personal address books. The method further includes generating a profile template for an uploaded personal contact of the first person when none exist in the central database. The second computing device may be a computer, a mobile phone, a pager, a television remote control, a PDA or combinations thereof. The group may be a group of people residing in a certain geographic area, a group of people belonging to a certain organization, or a group of all people on earth. The publicly available information may be data from telephone directories, business directories, marketing data, financial data or other legally accessible data. Each person's profile information may be verified by answering preset questions formulated based on group common knowledge. The method further includes grouping together into subgroups persons with the same field parameters. The method further includes providing communication tools for communications between the persons within the group or the subgroups.

In general, in another aspect, invention features a computer system comprising a first computing device, a storage device, profile templates for each person on earth stored in a central database stored in the storage device and a web-based address book application stored in the storage device. The web-based address book application includes a first webpage adapted to be viewed by a first person through a browser executing on a second computing device and a second webpage. The second computing device is adapted to connect to the first computing device via a network connection. The first webpage prompts the first person to login into the web-based address book application and to search the first own person's profile template stored in the central database. The second webpage displays the first person's retrieved profile template and includes means for the first person to update the first person's profile information, means for uploading the first person's personal address book, means for adding the updated profile information and uploaded personal address book to the first person's profile template, means for cross-correlating the uploaded names and contact information of the first person's personal contacts with information in the personal contacts' profile templates stored in the central database and means for updating the personal contacts' profile templates. The personal address book includes names and contact information of the first person's personal contacts.

In general, in another aspect, invention features an interactive web-based address book application stored in a first computing device and adapted to be accessed by a first person via a second computing device connecting to the first computing device via a network connection. The web-based address book application includes a first webpage adapted to be viewed by the first person through a browser executing on the second computing device and a second webpage also adapted to be viewed by the first person through the browser. The first webpage prompts the first person to log in the web-based address book application and to search the first person's own profile template stored in a central database. The second webpage displays the first person's profile template and includes means for the first person to update the first person's profile information, means for uploading the first person's personal address book, means for adding the updated profile information and uploaded personal address book to the first person's profile template, means for cross-correlating the uploaded names and contact information of the first person's personal contacts with information in the personal contacts' profile templates stored in the central database and means for updating the personal contacts' profile templates. The personal address book includes names and contact information of the first person's personal contacts.

In general, in another aspect, invention features a display device including first and second graphical user interfaces. The first graphical user interface includes a first row and a control. The first row comprises a prompt to a first person to login into a web-based address book application and to search the first person's own profile template stored in a central database. Actuation of the control initiates the searching and retrieval of the first person's profile template. The second graphical user interface includes one or more rows displaying the first person's retrieved profile template and additional controls. Activation of the additional controls allows the first person to update information in the first person's profile template, to upload the first person's personal address book, to add the updated profile information and uploaded personal address book to the first person's profile template, to cross-correlate the uploaded names and contact information of the first person's personal contacts with information in the personal contacts' profile templates stored in the central database and to update the personal contacts' profile templates. The personal address book includes names and contact information of the first person's personal contacts.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 is an overview diagram of a web-based address book system;

FIG. 2 is a schematic diagram of the common address book of FIG. 1;

FIG. 3 depicts a profile template as stored in the common address book of FIG. 1; and

FIG. 4 illustrates the process of creating the collaborative web-based address book of this invention.

### DETAILED DESCRIPTION OF THE INVENTION

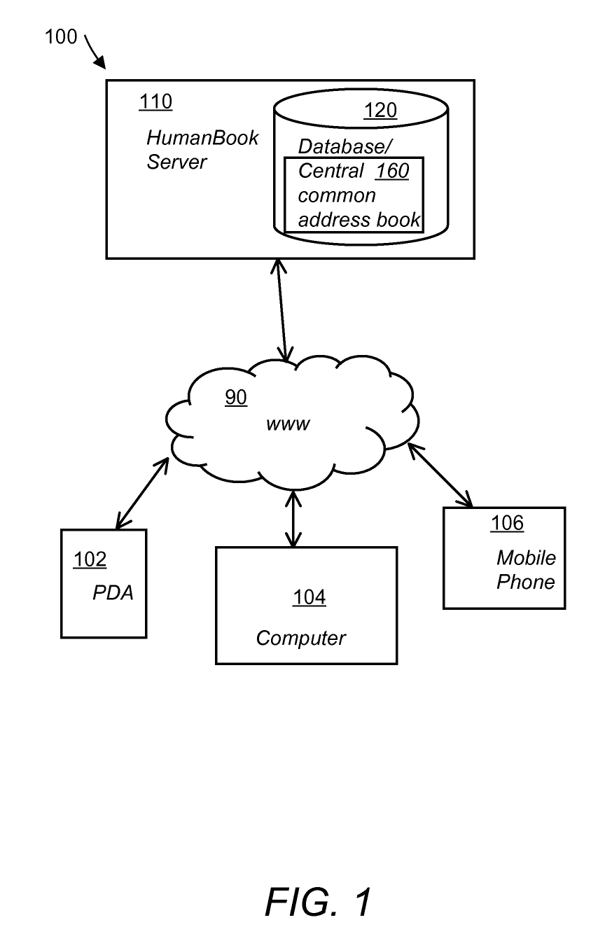

Referring to FIG. 1, a web-based address book 100 system includes a central common address book/Database 120, a server 110 and communication devices 102, 104, 106. The communication devices include a Personal Digital Assistant (PDA) 102, a computer 104, and a mobile phone 106. In other examples, the communication devices may be wired or wirelesses devices including a pager, a wireless laptop computer, a personal computer, a television remote control, or combinations thereof. The communication devices access the server 110 and database 120 via a network connection 90. In one example, network connection 90 is the Internet. In other examples, the network connection 90 may be a phone network, a cable network, or other wireless or a wired networks.

The central common address book 160 is created by the system administrator and stored in the server 110. This central common address book is the integrator of every person's profile, list of contacts (address books) and the distributor of people's contacts to every person. The contact information is stored in the server and is updated by people in real time.

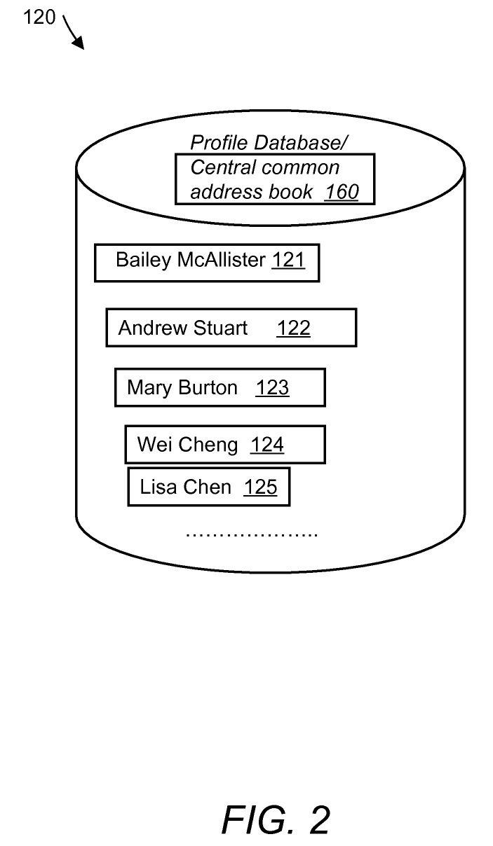

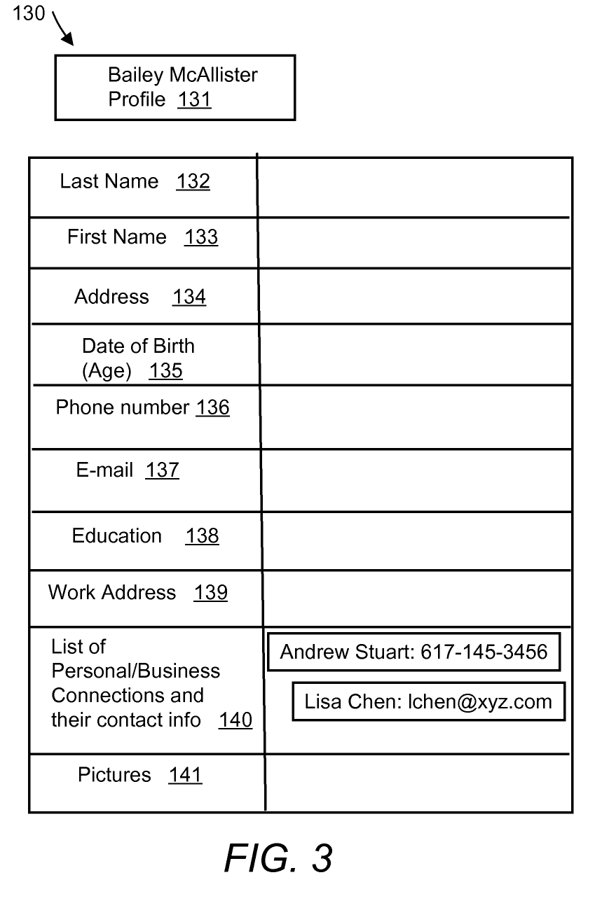

Referring to FIG. 2, central common address book/database 160 includes personal data profiles of people. Examples of people whose profiles are listed in database 160 are people residing in a certain geographic area or people belonging to a certain organization or group, or in general all people on earth. Database 160 also includes profiles of entities including businesses, educational institutions and organizations, among others. For every person or entity the system has a unique index preset and empty fields preserved for all attributes related to that person or entity. Even if a person had never logged into the system, his profile still exists and other people can link to it and leave contact info of that person in his profile. Referring to FIG. 3, the profile for Bailey McAllister 130 includes the unique preset index 131 and parameter fields for last name 132, first name 133, address 134, date of birth or age 135, phone number 136, education 138, work address 139, pictures 141, and lists of personal and business contacts 140, i.e., personal address book, among others. Basic information for each profile is preloaded by the system administrator based on publicly available data. The basic information is defined as information sufficient for identifying and matching a specific person with a specific profile. In one example, the basic information is a name and/or any of the other mentioned parameters. Publicly available data include data from phone directories, business directories, marketing data and financial data, among others. In other examples, other legally accessible data are also included. The basic profile information is published and then other people including the person to whom the profile belongs contribute, edit and modify the profile information. This unique feature of the system allows people to share knowledge about a person and record it to preset database fields of the person's profile. The profile index and the individual profile fields have unique locations, which can be searched and easily found. The system is self updated and the information is always current because people contribute to it and edit it. Since every piece of information has a unique location—once somebody changes it, all people can see the updated information because everyone is linked to the same index field of information. This web-based people directory system is a Web 2.0 website that combines the online social network attributes with the ability to contribute content and information while allowing users to exercise control over their data. Web 2.0 websites refer to web-based communities and hosted services, which facilitate creativity, collaboration and sharing between users. A more detailed discussion of Web 2.0 websites is presented in Wikipedia http://en.wikipedia.org/wiki/Web_{—}2, the contents of which are incorporated herewith.

The contact information in the web-based address book system is organized and is matched and linked to real people's profiles. In the example of FIG. 3, Bailey McAllister is the owner of an address book 140 (i.e., list of connections and their contact information) that includes the names of Andrew Stuart and Lisa Chen, as her connections. For Andrew Stuart a phone number is listed and for Lisa Chen an e-mail address is listed. The system matches Andrew Stuart's phone number as listed in Bailey McAllister's address book 140 to his personal preexisting profile 122 in database 120, shown in FIG. 2, and enters it into his profile phone number field 136. Similarly Lisa Chen's e-mail address is matched to her preexisting profile 125 in database 120, shown in FIG. 2, and entered into her profile e-mail information field 137. People whose contact information is uploaded by others and have not joined the service or activated their personal profile, are invited to join the service and fill in their profile information. This matching and cross-correlation of contact information is performed by the system administrator or the users of the system. In other examples an automatic tool matches the uploaded contact information to people's profiles.

Thus people invite other people to join this web-based address book service using the provided contact information. It is a promotional chain wave. The more people use the system and the more profiles are active, the better and more reliable services this system offers. A matrix of contact information is being formed.

Contact information, uploaded by many, is shared and a common address book is created. The common address book is usually updated in real time, enriched with additional data and new contacts. If profiles of two or more people are linked together, then it is implied that these two or more people share the contact information of each other. Access to the contact information of each other is granted according to contact owners' preferences. Users can manage their contact information access preferences and who, out of the connected profiles, can get their current contact info. If a profile was not visited by its owner and access preferences were not set, then default settings are in place. If contact info is not shared and not available to other users, other users can leave a message for that person on the system.

If any contact information changes, i.e. gets updated by another person or if a profile owner changes his own contact information, this change automatically updates the profile owner's contact information on all other users' contact books, which were linked to this profile. In this way a person's contact information is current and gets updated in real time.

People can also get the contact information of someone, whom they don't personally know, but want to contact, if the contact information is shared by somebody, who has contact access privileges. This system make is easy to communicate and network with other people and make new connections.

Updated contact information is distributed to authorized people and is available anytime for download or for usage on site. Special tools allow synchronization and export of information from the updated central address book to address books stored in people's client devices, such as mobile phones, PDAs, personal computers and pagers, among others.

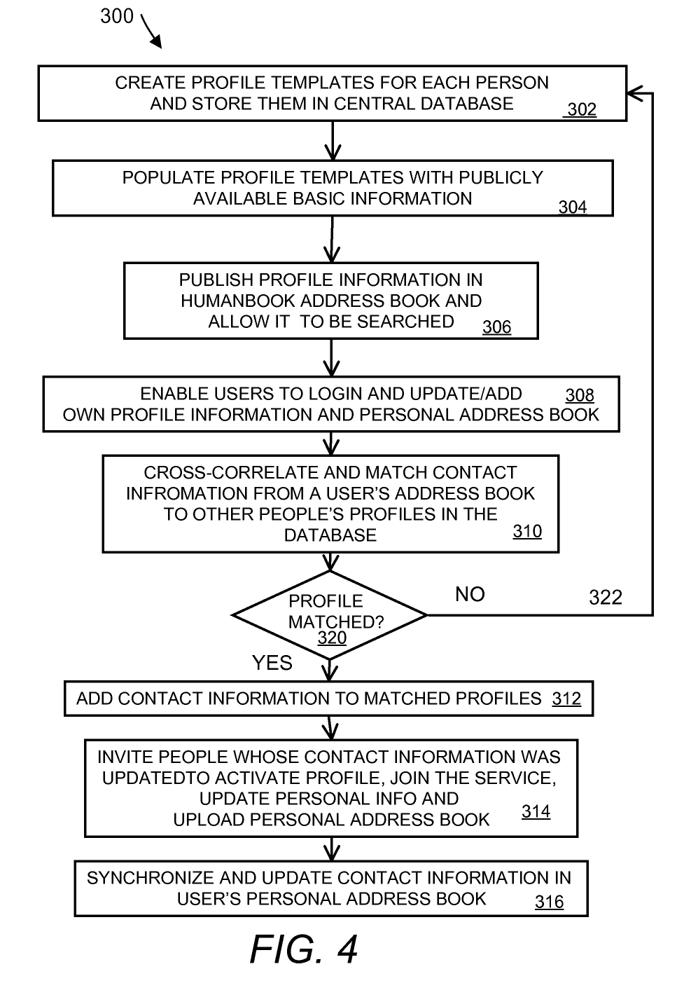

Referring to FIG. 4, the process 300 for generating the web-based common address book 120 includes the following steps. First, creating profile templates for each person on earth and storing these profile templates in a central database (302). Next, populating the profile templates with publicly available basic information (304) and then publishing the public profile information in the web-based address book (306) and allowing it to be searched. Users are allowed to login into the address book website, update their own profile information and upload their personal address book (308). Next, the system cross-correlates and matches contact information retrieved from users' personal address books to other people's profiles in the database (310). This matching of the contact information to a person's profile is done automatically or manually by the user or the administrator. If a profile match is found (320) the contact information is added to the matched profile (312). The person whose contact information was added is invited to activate his profile, join the service, update personal profile information and upload personal address book (314). The invitation may be sent by the system administrator, the user from whose address book the contact information was retrieved or any other user. All submissions are eponymous and can be traced back to the originator of the information. Finally the system synchronizes and updates the entered /updated contact information is in all users' personal address books (314). If a profile match was not found in step 320 a new profile is created and added in the database (322). The system is governed by rules that do not allow publishing of negative information in a profile, i.e., all published information is positively bound. All profile information entries are verified either by other members of the community to which the specific person belongs or by answering preset questions formulated based on common knowledge. In one example, a person's attendance of a particular school is verified based on answering a question about a teacher who taught at the particular school during the time period of reference. In this example, the question may be either the name of the teacher or subject matter taught by the teacher, or a specific event that happened in the teacher's presence.

Several embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for an online address book comprising:
generating a profile template for each person within a group and storing them in a central database;
populating each person's profile template with publicly available information;
publishing each person's profile template through a web-based address book application executing on a first computing device and wherein said web-based address book application is adapted to be accessed by a first person of said group through a browser executing on a second computing device, wherein said second computing device is adapted to connect to said first computing device via a network connection;
providing a first webpage adapted to be viewed by said first person via said browser for said first person to login into said web-based address book application and to search said first person's own profile template in said central database;
retrieving said first person's own profile template and displaying it in a second webpage adapted to be viewed by said first person through said browser;
uploading said first person's personal address book wherein said personal address book comprises names and contact information of the first person's personal contacts;
adding said uploaded personal address book to said first person's profile template; and
cross-correlating the uploaded names and contact information of the first person's personal contacts with information in said personal contacts' profile templates stored in said central database and updating said personal contacts' profile templates.

2. The computer implemented method of claim 1 wherein said profile template comprises one or more fields comprising last name, first name, address, age, date of birth, phone number, e-mail address, education background, work address, personal address book, personal contacts and photographs.

3. The computer implemented method of claim 2 further comprising selecting one or more of said fields to be publicly displayed in said profile template.

4. The computer implemented method of claim 2 further comprising updating said first person's profile information by said first person.

5. The computer implemented method of claim 4 further comprising displaying the updated profile template and uploaded personal address book of said first person in said second webpage.

6. The computer implemented method of claim 1 further comprising verifying and updating said first person's profile information by other persons of said group.

7. The computer implemented method of claim 5 further comprising updating said contact information of said first person's personal contacts in said first person's personal address book based on information in said personal contacts' profile templates.

8. The computer implemented method of claim 1 further comprising inviting said first person's personal contacts to join said web-based address book application, verify information in their personal profile templates and then upload their personal address books.

9. The computer implemented method of claim 1 further comprising generating a profile template for an uploaded personal contact of said first person when none exist in said central database.

10. The computer implemented method of claim 1 wherein said second computing device comprises one of a computer, a mobile phone, a pager, a television remote control, a PDA or combinations thereof.

11. The computer implemented method of claim 1 wherein said group comprises one of a group of people residing in a certain geographic area, a group of people belonging to a certain organization, or a group of all people on earth.

12. The computer implemented method of claim 1 wherein said publicly available information comprises data from one of telephone directories, business directories, marketing data, financial data or other legally accessible data.

13. The computer implemented method of claim 1 wherein each person's profile information is verified by answering preset questions formulated based on group common knowledge.

14. The computer implemented method of claim 2 further comprising grouping together into subgroups persons with the same field parameters.

15. The computer implemented method of claim 14 further comprising providing communication tools for communications between said persons within the group or said subgroups.

16. A computer system comprising a first computing device, a storage device, profile templates for each person on earth stored in a central database stored in said storage device and a web-based address book application stored in said storage device, wherein said web-based address book application comprises:
a first webpage adapted to be viewed by a first person through a browser executing on a second computing device, wherein said second computing device is adapted to connect to said first computing device via a network connection, wherein said first webpage prompts said first person to login into said web-based address book application and to search said first own person's profile template stored in said central database;
a second webpage displaying said first person's retrieved profile template and comprising means for said first person to update said first person's profile information, means for uploading said first person's personal address book wherein said personal address book comprises names and contact information of the first person's personal contacts, means for adding said updated profile information and uploaded personal address book to said first person's profile template, means for cross-correlating the uploaded names and contact information of the first person's personal contacts with information in said personal contacts' profile templates stored in said central database and means for updating said personal contacts' profile templates.

17. An interactive web-based address book application stored in a first computing device and adapted to be accessed by a first person via a second computing device connecting to said first computing device via a network connection comprising:
a first webpage adapted to be viewed by said first person through a browser executing on said second computing device, wherein said first webpage prompts said first person to login into said web-based address book application and to search said first person's own profile template stored in a central database;
a second webpage also adapted to be viewed by said first person through said browser, wherein said second webpage displays said first person's profile template and comprises means for said first person to update said first person's profile information, means for uploading said first person's personal address book wherein said personal address book comprises names and contact information of the first person's personal contacts, means for adding said updated profile information and uploaded personal address book to said first person's profile template, means for cross-correlating the uploaded names and contact information of the first person's personal contacts with information in said personal contacts' profile templates stored in said central database and means for updating said personal contacts' profile templates.

18. A display device comprising:
a first graphical user interface comprising a first row and a control and wherein said first row comprises a prompt to a first person to login into a web-based address book application and to search said first person's own profile template stored in a central database, and wherein actuation of said control initiates said searching and retrieval of the first person's profile template;
a second graphical user interface comprising one or more rows displaying said first person's retrieved profile template and additional controls and wherein activation of said additional controls allows said first person to update information in said first person's profile template, to upload said first person's personal address book wherein said personal address book comprises names and contact information of the first person's personal contacts, to add said updated profile information and uploaded personal address book to said first person's profile template, to cross-correlate the uploaded names and contact information of the first person's personal contacts with information in said personal contacts' profile templates stored in said central database and to update said personal contacts' profile templates.
